(19) United States
(12) Patent Application Publication
(10) Pub. No.: US 2008/0176702 A1
(43) Pub. Date: Jul. 24, 2008

(54) Torque vectoring system

(76) Inventor: Dan J. Showalter, Plymouth, MI (US)

Correspondence Address: BRINKS HOFER GILSON & LIONE, P.O. BOX 10395, CHICAGO, IL, 60610, US

(21) Appl. No.: 11/655,683

(22) Filed: Jan. 19, 2007

(51) Int. Cl. F16H 48/22; F16H 37/08

(52) U.S. Cl. 475/204; 475/201

(57) ABSTRACT

A system for a torque vectoring differential in motor vehicle applications is provided. The system includes a shaft (30), a first gear (44), a second gear (46), and a set of planet gears (50). The first gear (44) engages and rotates together with the shaft (30). The first and second gear (44, 46) both engage the set of planet gears (50) thereby forming a gear ratio between the first and second gear (44, 46) other than one. A carrier (48) rotates about the shaft central axis (42) and locates the planet gears (50) about the circumference of the carrier (48) to engage both the first and second gears (44, 46). In a normal mode of operation, the carrier (48), the first gear (44), and the second gear (46) all rotate about the shaft (30) at shaft speed. However, in an enhanced torque mode, the clutch pack (56) is compressed transferring torque from the carrier (48) to a mechanical ground (62).

### FIELD OF THE INVENTION

This invention relates to a system for a motor vehicle differential design which provides axle torque vectoring capabilities.

### BACKGROUND OF THE INVENTION

Conventional rear-wheel drive motor vehicles provide wheel driving torque through a propeller shaft coupled through a differential to left and right half-shafts. Front-wheel drive vehicles couple to front wheel drive half-shafts through a differential driven by a transaxle. Normally, four-wheel drive and so-called all-wheel drive vehicles also use differentials to drive front and rear axles. Rear wheel drive vehicles also use a differential to drive the rear half shafts. Differentials allow differences in wheel rotational speed to occur between the left and right side driven half-shafts (and between front and rear axles in some applications). The earliest and most basic designs of differentials are known as open differentials in that they provide equal torque between the two half-shafts and do not operate to control the relative rotational speeds of the axle shafts. A well known disadvantage of open differentials occurs when one of the driven wheels engages the road surface with a low coefficient of friction (μ) with the other having a higher μ. In such case, the low tractive force developed at the low μ contact surface prevents significant torque from being developed on either axle. Since the torque between the two axle shafts is relatively equal, little total tractive force can be developed to pull the vehicle from its position. Similar disadvantages occur in dynamic conditions when operating, especially in low μ or so-called split μ driving conditions.

The above limitations of open differentials are well known and numerous design approaches have been employed to address such shortcomings. One approach is known as a limited slip or locking differential. These systems are typically mechanically or hydraulically operated or use other strategies to attempt to couple the two axle shafts together to rotate at nearly equal speeds. Thus, in this operating condition, the two axles are not mutually torque limited. A mechanically based locking or limited slip differential typically uses a clutch pack or friction material interface which locks the two axles together when a significant speed difference between the axles occurs. Other systems incorporate fluid couplings between the axles which provide a degree of speed coupling.

Although the above described locking and limited slip differential systems provide significant benefits over open differentials in many operating conditions, they too have significant limitations. Reliability and warranty problems are issues with many locking differential designs. Locking differentials using a mechanical friction interface are subject to wear of the friction materials. These locking and limited slip differential systems can only remove driving torque from the faster axle half-shaft and add it to the slower axle half-shaft. Sometimes it is desirable to reduce the driving force of the slower of the right or left wheels and add driving force to the faster of the right or left wheels.

Vehicle powertrain and suspension system designers consider forces acting at the tire contact patches to achieve desirable traction, braking, handing and steering behavior for the vehicle. The resultant forces acting at the tire patches can be resolved into longitudinal and lateral vector components. Automotive designers often desire to manage these tire force vectors to provide desirable handling characteristics, particularly those referred to as oversteer and understeer conditions. It is well known to use braking torque to provide wheel contact vectoring to prevent oversteer and understeer conditions in maneuvering around curves. Such electronic controlled braking systems are known by various names and acronyms including dynamic stability control (DSC), and electronic stability program (ESP). These systems, however, only operate in an energy dampening (i.e. braking) mode. It would be highly desirable to provide wheel contact vectoring through a managed re-distribution of torque at each wheel.

### BRIEF SUMMARY OF THE INVENTION

This invention relates to a system for a torque vectoring differential in motor vehicle applications. The system allows for overdriving or underdriving of a wheel by using a clutch to control torque and speed generated between the differential carrier and the wheel. The system includes a shaft, a first gear, a second gear, a carrier and a set of planet gears. The first gear engages and rotates together with the shaft. The second gear engages and rotates together with the differential carrier. Both the first and second gear both rotate about the shaft central axis and engage the set of planet gears thereby forming a gear ratio between the first and second gear other than one. For example, the first gear may have more teeth than the second gear. Each of the planet gears are housed in the carrier about the first and second gear. The carrier rotates about the shaft central axis and locates the planet gears about the circumference of the carrier to engage both the first and second gears. The carrier also includes an extended portion with teeth about an inner circumference to engage a clutch pack. In a normal mode of operation, the carrier, the first gear, and the second gear all rotate about the shaft at shaft speed. However, in an torque vectoring mode, the clutch pack is compressed transferring torque from the carrier to a mechanical ground. As such, the carrier and the second gear rotate at a variable speed based on the torque transferred through the clutch pack.

In other aspects of the invention, the clutch pack may be compressed by an electromagnetic force generated from a coil assembly. Electromagnetic force from the coil assembly may pull on an armature causing a retaining plate to compress the clutch pack. The retaining plate may be located adjacent to the carrier. Further, the retaining plate may include spirally formed channels such that the motion of the carrier causes lubrication fluid to flow into the center of the clutch pack. Similarly, the carrier may include scoops located about the circumference of the carrier configured to direct lubrication fluid into the center of the carrier.

These and other aspects and advantages of the present invention will become apparent upon reading the following detailed description of the invention in combination with the accompanying drawings.

### BRIEF DESCRIPTION OF THE DRAWINGS

FIG. 1 is a sectional top view of a torque vectoring differential system in accordance with one embodiment of the present invention;

FIG. 2 is a sectional top view of a torque vectoring assembly;

FIG. 3 is a perspective view of a housing and coil assembly;

FIG. 4 is an assembly view of the armature;

FIG. 5 is a perspective view of the armature and the reaction plate;

FIG. 6 is a perspective view of the armature attached to the reaction plate;

FIG. 7 is a perspective view of the torque vectoring assembly illustrating the alignment of the armature with the grounding ring;

FIG. 8 is a perspective view of the torque vectoring assembly illustrating the assembly of the clutch pack;

FIG. 9 is a perspective view of the torque vectoring assembly illustrating attachment of the retaining plate;

FIG. 10 is a perspective view of a carrier including planet gears and scoops;

FIG. 11 is a perspective view of the torque vectoring assembly illustrating the alignment of the carrier to the clutch pack;

FIG. 12 is a perspective view of the torque vectoring assembly illustrating insertion of the intermediate shaft;

FIG. 13 is a perspective view of the torque vectoring assembly illustrating insertion of the first sun gear; and

FIG. 14 is a perspective view of the torque vectoring assembly illustrating insertion of the second sun gear.

### DETAILED DESCRIPTION OF THE INVENTION

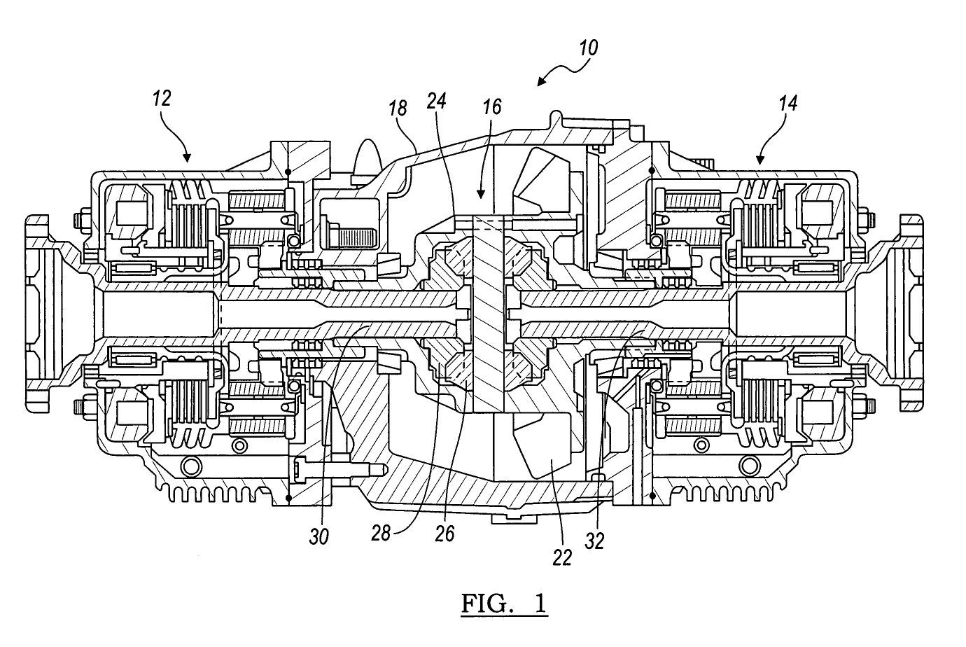

A torque vectoring differential system is shown in FIG. 1 and is generally designated by reference number 10. The basic components of system 10 include a left torque vectoring assembly 12, a right torque vectoring assembly 14, and differential gear assembly 16. The basic mechanical features of the differential assembly 16 will be described followed by a description of the torque vectoring assemblies 12, 14.

Differential assembly 16 shown in FIG. 1 includes basic elements of typical differential assemblies, which include ring gear 22 which is driven by a hypoid or bevel gear pinion (not shown) coupled with the vehicle's propeller shaft. Ring gear 22 is coupled with differential carrier 24 which rotates with the ring gear 22. Two or more pinion gears 26 are rotatable about a common differential shaft mounted to the carrier. Pinion gears 26 mesh with a pair of side gears 28 which are in turn splined or otherwise connected with a pair of shafts 30 for the left and right hand wheels of the associated motor vehicle. The above described components of differential 16 are common components of so-called open differentials. Front wheel drive vehicles often use a differential which is a planetary gear set. These systems however operate fundamentally like the design described above and can be used with this invention. Each of the torque vectoring assemblies 12, 14 may be constructed in a similar fashion. Accordingly, the discussion and figures hereafter may be equally applied to either assembly.

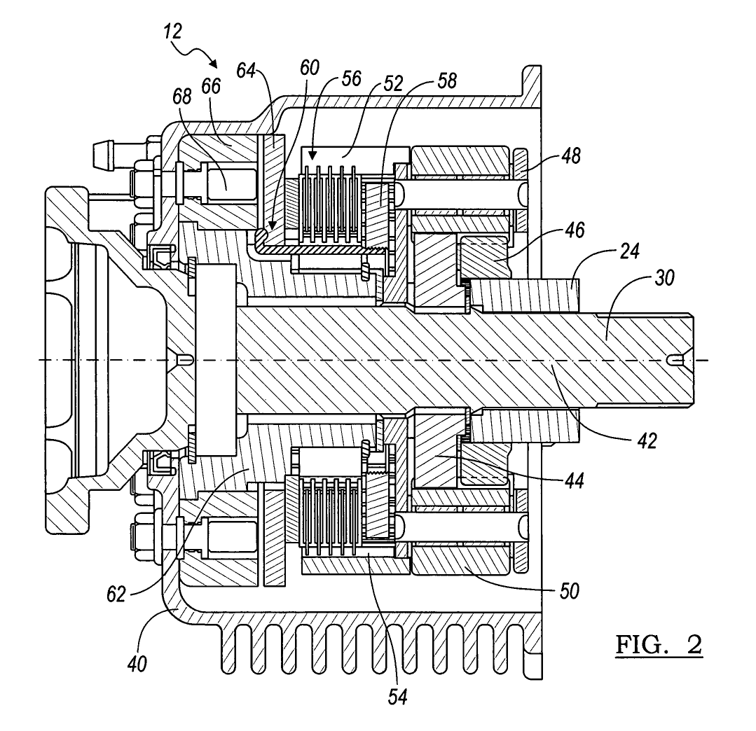

Now referring to FIG. 2, torque vectoring assembly 12 includes a housing 40 coupled to the differential housing 18 such that the housing 40 is mechanically grounded relative to a vehicle chassis. A first sun gear 44 engages the shaft 30 through a splined or geared engagement. Accordingly, the first sun gear 44 rotates together with and at the same speed as the shaft 30. The first sun gear 44 engages a plurality, for example four, planet gears 50 that are carried on and housed in a carrier 48. The first sun gear 44 includes a plurality of teeth about the outer circumference of the first sun gear 44. In addition, a second sun gear 46 is provided. The second sun gear 46 engages the differential carrier 24 about an inner circumference and the plurality of planet gears 50 about an outer circumference. The second sun gear 46 has a different number of teeth than the first sun gear 44. The first sun gear 44 may have more teeth than the second sun gear 46 to overdrive the shaft 30. Alternatively, the first sun gear 44 may have fewer teeth to underdrive the shaft 30. This can be implemented by varying the pitch, pitch diameters, and/or profile of the gears. For example, if an optimum gear match included 38 teeth, the first sun gear 44 could include 40 teeth while the second sun gear 46 could include 36 teeth. Accordingly, a gear ratio of 1.11 would be created allowing the shaft 30 to be overdriven or underdriven by 10% at such time that the relative rotational speed of the carrier 48 is reduced to zero. At least one, but preferably each of the planetary gears 50 engage the first and second sun gears 44, 46. The carrier 48 also includes a portion 52 extending from the carrier 48 and including teeth 54 about an inner circumference. The teeth 54 mesh with external teeth on clutch plates from the clutch pack 56.

In a first mode of operation, which may be a normal mode of operation where the vehicle is being driven straight and the left and right wheel speeds are equal, the clutch pack 56 is not compressed allowing a first set of clutch plates to rotate relative to a set of clutch plates. The first set of clutch plates engage the teeth 54 and thus the carrier 48 rotates freely relative to the second set of clutch plates in the first mode. Accordingly, in the first mode, the shaft 30, the first gear 44, the second gear 46, and the carrier 48 all rotate about the shaft central axis 42 at the shaft speed. As such, the planet gears 50 do not rotate about their central axis, but rotate with the carrier 48 about the shaft central axis 42.

In a second mode of operation, for example an enhanced torque mode, the clutch pack 56 is compressed. To compress the clutch pack 56, the coil assembly 66 includes a coil 68 that forms an electromagnet. The coil assembly 66 is fastened to the housing 40 and mechanically grounded through the housing 40. For example, coil assembly 66 may be fastened to the housing 40 using bolts. In addition, a grounding ring 62 is also mechanically grounded to the housing 40 through the coil assembly 66. A armature 64 is located adjacent the coil assembly 66. The electromagnetic force generated by current running through the coils 68 pulls the armature 64 toward the magnetic coil 68. The armature 64 in turn pulls the armature assembly 60 toward the magnetic coil 68. In addition, the armature assembly 60 may engage a retaining plate 58, for example through a threaded engagement. Accordingly, the motion of the armature assembly 60 pulls the retaining plate 58 towards the coil 68 thereby compressing the clutch pack 56.

As the retaining plate 58 compresses the clutch pack 56, the first set of clutch plates that engage the teeth 54, frictionally engage the second set of clutch plates. Accordingly, the first set of clutch plates transfer torque to the second set of clutch plates, which are engaged with the grounding ring 62. In this mode, the first sun gear 44 rotates at the same speed as the shaft 30. However, the gear ratio between the first and second sun gear 44, 46 forces the shaft 30 and ultimately the vehicle tire to rotate faster than the differential carrier 24 and the ring gear 22. Meanwhile, the carrier 48 and planet gears 50 rotate at a variable speed that is determined based on the degree of frictional engagement of the clutch pack 56. Accordingly, torque from the carrier 48 may be amplified, for example by ten times, through the first and second gears 44, 46, generating opposite torques between the shaft 30 and the differential carrier 24. Referring back to FIG. 1, in this mode as the torque vectoring unit 12 increases the speed of its corresponding shaft 30 relative to the speed of the differential carrier 24, the speed of the corresponding side gear 28 is increased causing a rotation of the pinion gear 26 about its axis. As the pinion gear 26 rotates, it transfers by the engagement of its teeth the same speed difference in the opposite direction to the opposing side gear which is engaged to the opposing shaft. This side-to-side torque transfer will occur even in the absence of any input torque from the hypoid or bevel pinion to the ring gear 22.

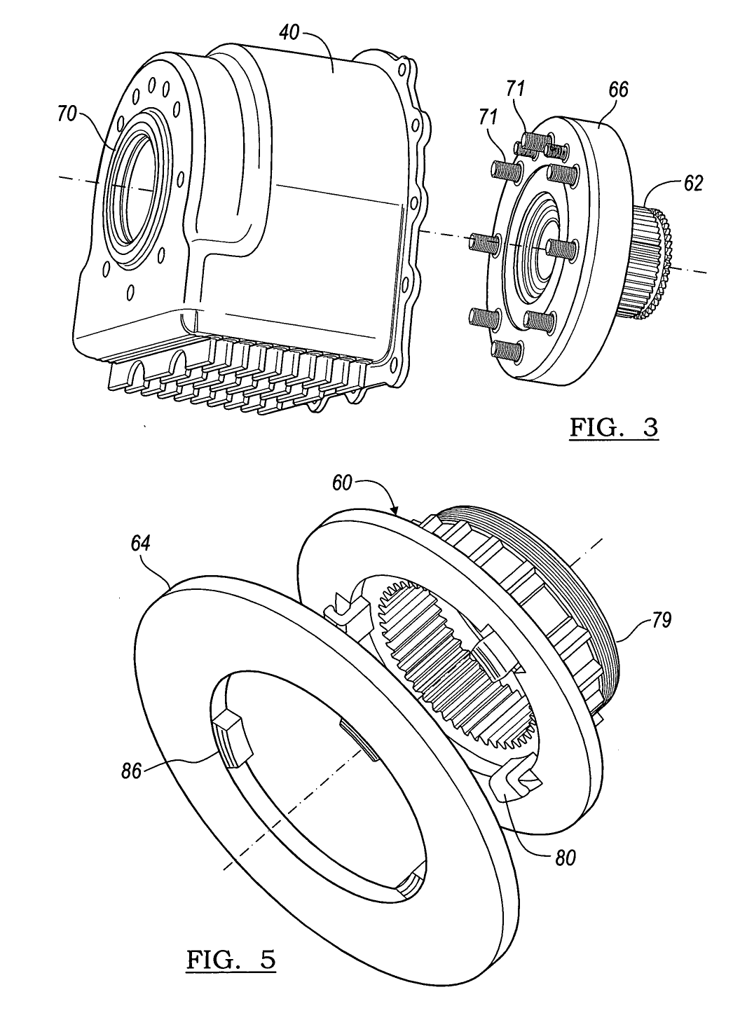

Additional details of the torque vectoring assembly 12 are provided with reference to FIGS. 3-14. The torque vectoring assembly 14 is a mirrored construction of torque vectoring assembly 12. In FIG. 3, the housing 40 is provided for the torque vectoring assembly 12. A seal 70 is pressed into an opening in the housing 40. The seal 70 will prevent the leakage of lubrication fluid between the shaft 30 and the housing 40. The housing 40 may be formed from aluminum to reduce weight. Although, it is understood that the housing 40 may be formed from steel or other rigid materials it is preferable for the material to be non-ferrous so that it does not interfere with the optimal flow of magnetic flux from the coil housing 66 through the armature 64. The grounding ring 62 is pressed into the coil assembly 66. The coil assembly 66 may be bolted to the housing 40 thereby mechanically grounding the coil assembly 66 and grounding ring 62 through the housing 40 and preventing the rotation thereof with respect to the differential housing 18 and a vehicle chassis. The coil assembly 66 also includes coil terminals 71 allowing electrical connection to the coil 68 for electromagnetic actuation of the clutch pack 54.

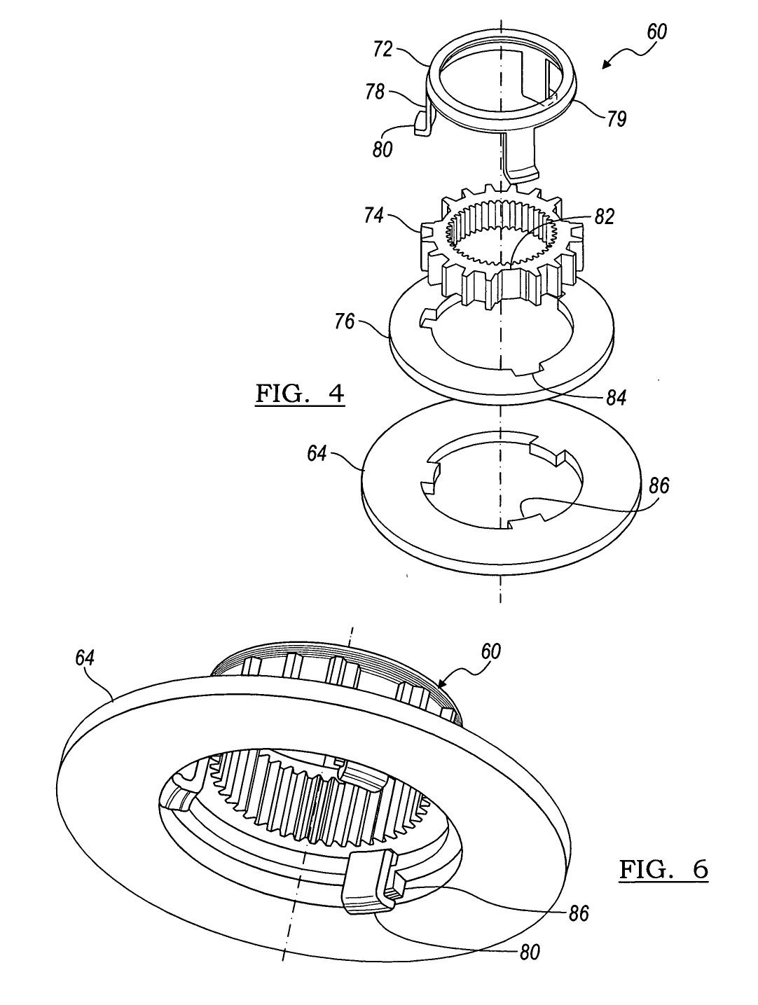

Referring now to FIG. 4, the armature assembly 60 includes the armature 64, a tube portion 72, a ring 74, and a plate 76. The armature 64 maybe formed from a ferrous material. The tube portion 72 may be constructed of aluminum, although other preferably non-ferrous rigid material may be used. A threaded segment 79 is located at a first end of the tube portion 72. A second segment of the tube portion 72 extends from the threaded segment 79 to a segmented flange 80 at the second end of the tube portion 72. The second segment may be formed from a plurality of legs 78, for example three legs extending from the threaded segment 79 to the flange 80. The legs 78 may be spaced equally about the circumference of the tube portion 72, for example at 120° increments. The legs 78 may be of equal size and length or alternatively may have different sizes or different lengths. Further, one of ordinary skill in the art would understand that other configurations of legs may be used including legs that have different lengths or that are not equally spaced about the circumference of tube portion 72.

The ring 74 may be made from a metal or other rigid material, for example steel. The ring 74 includes a first set of teeth around the internal circumference and a second set of teeth around the external circumference of the ring 74. In addition, the ring 74 may include slots 82 configured to slidingly receive the legs 78 from the tube portion 72. Accordingly, the legs 78 of the tube portion 72 are received in the recesses 82 over the ring portion 74. The plate 76 is located adjacent to the ring 74 and slidingly engaged to the legs 78 of the tube portion 72 extend through recesses 84 in the inner circumference of the plate 76. The plate 76 may be made from a metal or other preferably non-ferrous rigid material, for example stainless steel.

As shown in FIG. 5, the tube portion 72, the ring portion 74, and the plate 76 assemble together to form the armature assembly 60 with the threaded segment 79 extending from a first end of the armature assembly 60 and the flanges 80 on the tip of the legs 78 extending from the opposite end of the armature assembly 60. The legs 78 extend from the threaded segment 79 through recesses in the ring 74 and the plate 76 to rotationally but slidingly align the tube portion 72. The plate 76 is positioned in the assembly against a surface on the grounding ring 62. In addition, the legs 78 may extend through the inner circumference of the armature 64. The armature 64 may include tabs 86, such that the flanges 80 may engage the tabs 86 by rotating the armature 64 with respect to the tabs 86 as shown in FIG. 6. Accordingly, the armature 64 becomes affixed to the armature assembly 60 such that movement of the armature 64 by the electromagnetic force from the coil 68 will also cause motion of the tube portion 72 of the armature assembly.

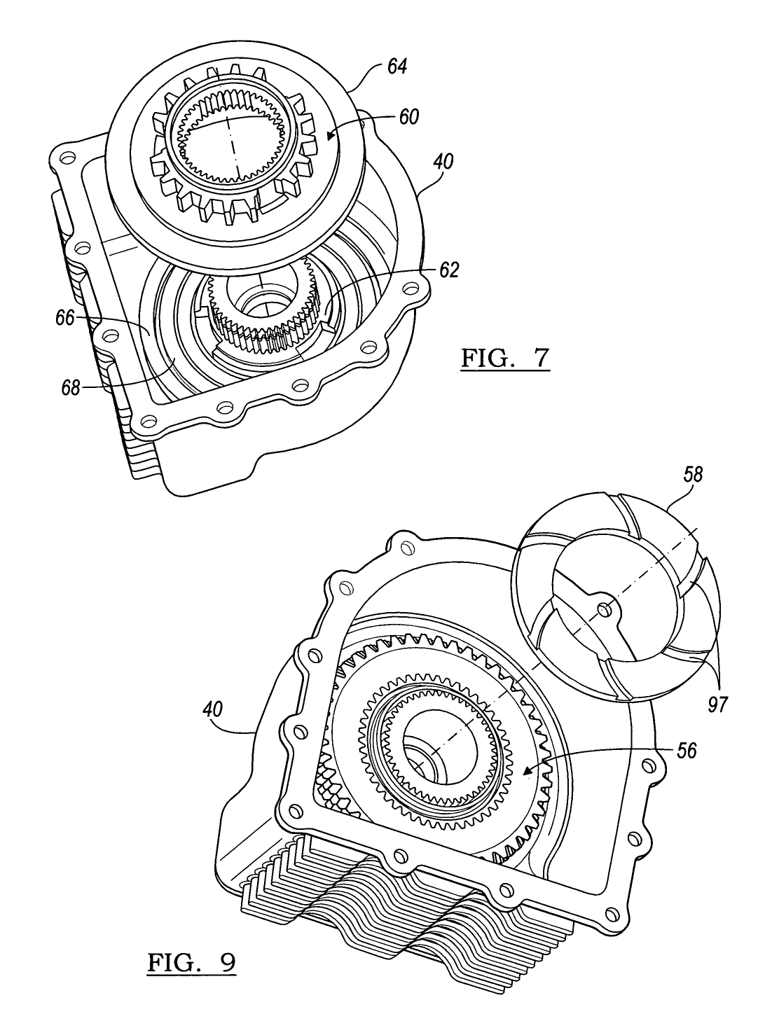

Now referring to FIG. 7, the armature assembly 60 along with the armature 64 are inserted over the grounding ring 62, such that the teeth around the inner circumference of the armature assembly 60 rotationally engage the teeth about the outer circumference of the grounding ring 62. However, the teeth on the inner surface of the armature 60 and the teeth on the outer surface of the grounding ring 62 allow a linear motion of the armature assembly 60 along the central axis 42 of the shaft 30 while preventing rotational motion about the central axis 42. This allows the armature assembly 60 to move toward but not contact the coil assembly 66 when the coil 68 is activated causing the clutch pack 56 to compress.

Now referring to FIG. 8, assembly of the clutch pack 56 is illustrated. The clutch pack 56 includes a first set of clutch plates 92, a second set of clutch plates 94, and a set of wave springs 96. The first set of clutch plates 92 include teeth about the external circumference of each clutch plate to engage the carrier 48. The wave springs 96 and the second set of clutch plates 94 have an outer diameter small enough to rotate freely with respect to the carrier 48. The second set of clutch plates 94 include teeth about an internal circumference of each clutch plate. As such, the teeth around the outer circumference of the armature assembly 60 engage the teeth in the inner circumference of the second set of clutch plates 94. However, the first set of clutch plates 92 and the wave springs 96 have a large enough inner diameter such that they are not engaged by the outer teeth of the armature 60. The first set of clutch plates 92, the wave springs 96, and the second set of clutch plates 94 are sequentially located over the ring portion 74. In one example, a clutch plate from the first set of clutch plates 92 is placed over the ring portion 74, then a wave spring 96, then a clutch plate from the second set of clutch plates 94, and then the sequence is repeated. However, one of ordinary skill in the art could readily understand that other sequences may be readily used, for example a wave spring between each clutch plate. The wave springs 96 are provided to reduce clutch drag and act as a return spring between the first and second set of clutch plates 92, 94.

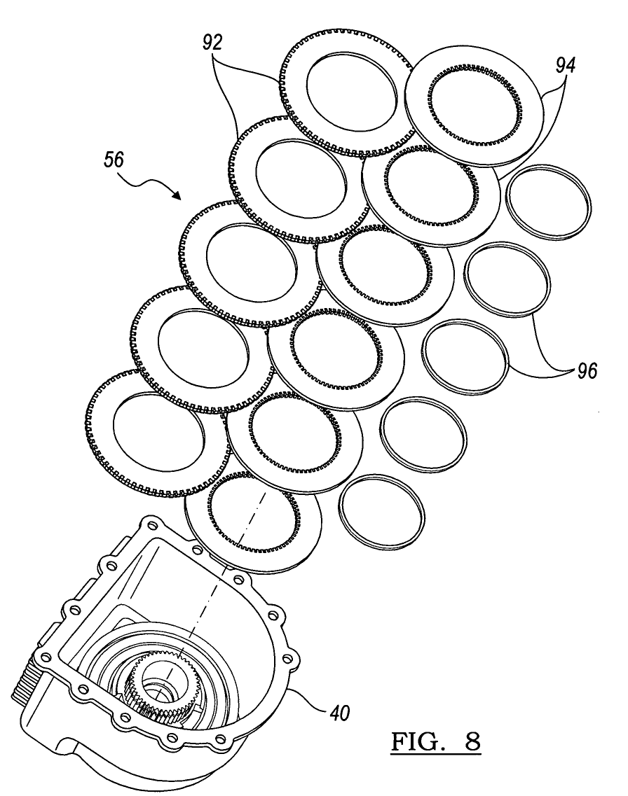

Now referring to FIG. 9, insertion of the retaining plate 58 is illustrated. The retaining plate 58 is threaded about its inner circumference and is configured to threadedly engage the threaded segment 79 of the tube portion 72. Accordingly, the retaining plate 58 is screwed onto the threaded segment 79 of the tube portion 72. In addition, the threads of the retaining plate 58 and the threads of the tube portion 72 are configured for example such that one rotation of the retaining plate 58 causes a one millimeter displacement of the retaining plate 58 along the central axis 42 of the shaft 30. Accordingly, the retaining plate 58 may be tightened to fully compress the clutch plates 92, 94 and wave springs 96 of the clutch plate pack 56 and then backed off to provide a desired clutch pack clearance. For example, the retaining plate 58 may be backed off 1.5 turns for a 1.5 millimeter clutch pack clearance. Then the threads may be staked to prevent the retaining plate 58 from backing off of the tube portion 72 of the armature assembly 60. This allows for easy assembly of the torque vectoring assembly 12 and adjustment of the clutch pack clearance. The retaining plate 58 may also include grooves for example, spirally formed channels 97 in the surface of the retaining plate 58. The channels 97 may be formed on the face of the retaining plate 58 located opposite the clutch pack 56. Accordingly, a moving component located adjacent channels 97 of the retaining plate 58, for example the carrier 48, will cause a flow of lubricating fluid to the inside of the clutch pack 56 due to rotation of the adjacent part. Accordingly, the spirally formed channels 97 may expand in diameter rotationally in a direction opposite the direction of the rotation of the adjacent component. The retaining plate 58 may be formed from aluminum although other metals or rigid materials may be used.

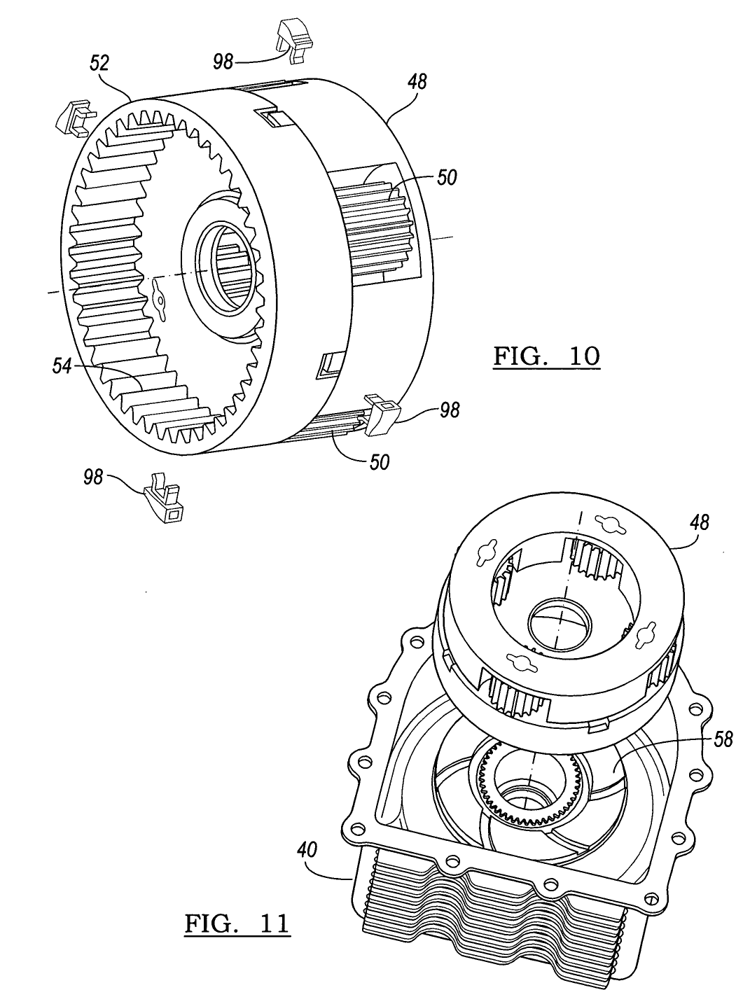

Now referring to FIG. 10, a perspective view of the carrier 48 is provided. The carrier 48 may be located adjacent to the retaining plate 58, as described above. The carrier 48 may include a portion 52 extending from the carrier. The portion 52 may include teeth 54 about an internal circumference of the extended portion 52. The carrier 48 may also include a set of planet gears 50 equally spaced about the carrier 48. For example, the carrier 48 may include four planet gears 50 positioned every 90° about the circumference of the carrier 48. The planet gears 50 may be pinned into a wall of the carrier 50 and configured to rotate about the pin with teeth of the planet gears 50 extending beyond the wall of the carrier 48 to engage other components. The carrier 48 may include scoops 98 having an opening facing the direction of rotation of the carrier 48. The scoops 98 direct lubricating fluid from the opening of the scoop 98, through an opening in the carrier 48, and into the center of the carrier 48. The scoops 98 may be located about the circumference of the carrier 48. For example, four scoops may be located every 90° about the circumference of the carrier 48. The scoops 98 may be formed from nylon and may clip into openings in the carrier 48. Although, one of ordinary skill in the art would understand that other scoop configurations including scoop spacing or material may be utilized within the scope of the present invention.

Now referring to FIG. 11, the carrier 48 may be located over the retaining plate 58 and clutch pack 56. The teeth 54 are configured to engage the teeth on the first set of clutch plates 92. Accordingly, the teeth on the first set of clutch plates 92 will need to be aligned prior to sliding the carrier 48 over the clutch pack 56. As such, the teeth 54 engage the first set of clutch plates 92 of the clutch pack 56 and are configured to rotate in conjunction therewith about the shaft central axis 42.

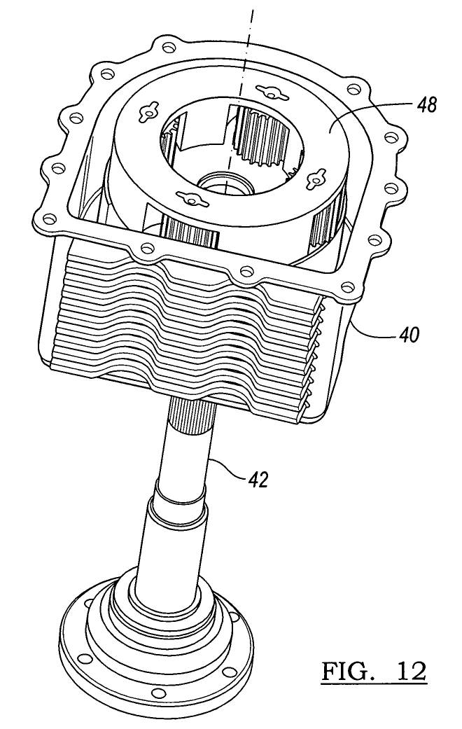

Now referring to FIG. 12, the shaft 30 is inserted through the housing 40, as well as, the other components of the torque vectoring assembly 12. The shaft 30 may be formed from steel and may be induction heat treated due to the amount of torque transferred therethrough. As such, the shaft 30 seats against the seal 70 in the housing 40 to prevent the leakage of lubrication fluid from the torque vectoring assembly 12.

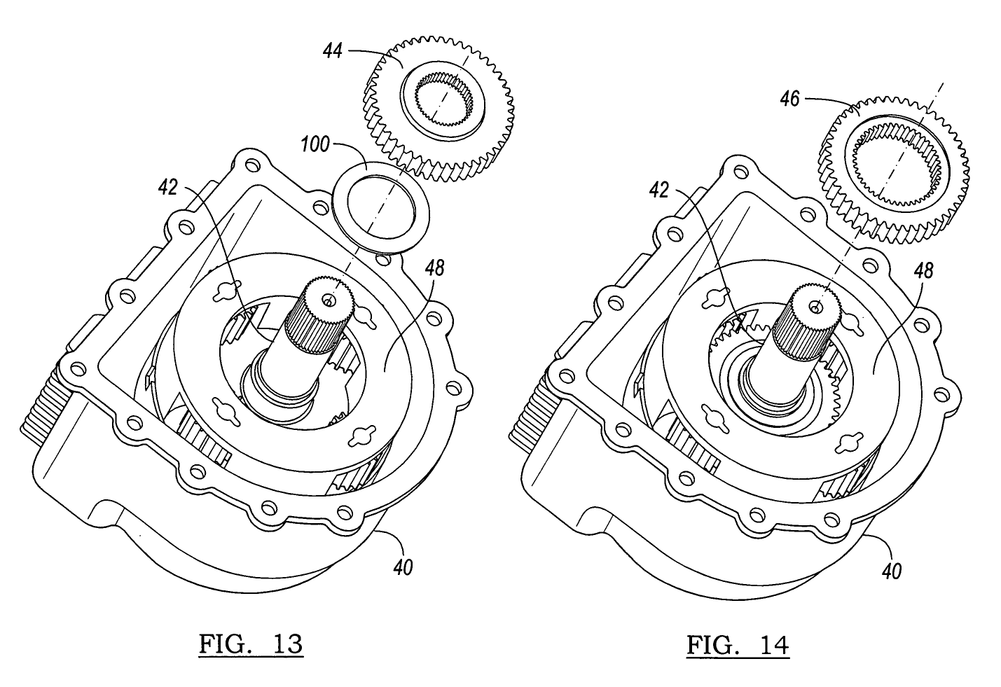

Now referring to FIG. 13, a thrust washer 100 may be inserted over the shaft 30 and against the carrier 48. Then a first sun gear 44 may be inserted over the shaft 30. The first sun gear 44 may include teeth along an inner circumference that is configured to engage teeth in the shaft 30 causing the first sun gear 44 to rotate in conjunction with the shaft 30 about the shaft central axis 42. In addition, the sun gear 44 includes a plurality of teeth located about the outer circumference of the sun gear 44 that are configured to engage the planet gears 50 located in the carrier 48. The first sun gear 44 may be formed from steel, however, other rigid materials may also be used.

Now referring to FIG. 14, a second sun gear 46 may be located over the shaft 30. The second sun gear 46 may be formed from steel, however, other rigid materials may be used. The second sun gear 46 includes a plurality of teeth around the outer circumference of the second sun gear 46 that also engage the planet gears 50 of the carrier 48. However, the number of teeth, size of the teeth, or pitch of the teeth are different from the first sun gear 44. In this arrangement, the difference in the number of teeth between the first and second sun gears must be a multiple of the number of pinions. Accordingly, a gear ratio is generated between the first and second sun gear 44, 46 while both gears are engaged with the planet gears 50 located about the carrier 48. Further, in the embodiments shown, the first sun gear 44 and the second sun gear 46 are both engaged with all four of the planet gears contained within the carrier 48. Although one of ordinary skill in the art would recognize that a greater or fewer number of planet gears 50 may be incorporated into the carrier 48 and utilized in conjunction with the first and second sun gear 44, 46. Further, it is also readily apparent that different gear ratios may be developed between a first and second sun gear 44, 46. However, in the example described, a gear ratio of 1.11 may be readily used to increase the torque provided to the wheel through the shaft 30.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A torque vectoring system for controlling torque delivered to an axle shaft of a motor vehicle through a differential including a differential carrier, the torque vectoring system comprising:
a shaft (30) configured to receive a torque output from the differential (16) and rotate about a shaft central axis (42);
a first gear (44) in communication with the shaft (30) and configured to rotate in conjunction therewith about the shaft central axis (42);
a second gear (46) in communication with the differential carrier (24) and configured to rotate about the shaft central axis (42), wherein the first and second gear (44, 46) have a gear ratio other than one; and
a set of planet gears (50) in communication with the first and second gears (44, 46).

2. The system according to claim 1, wherein at least one planet gear of the set of planet gears (50) engage both the first and second gear (44, 46).

3. The system according to claim 1, wherein each of the planet gears of the set of planet gears (50) engage both the first and second gears (44, 46).

4. The system according to claim 1, wherein the first and second gears (44, 46) are sun gears.

5. The system according to claim 1, wherein the first gear (44) has a different number of teeth than the second gear (46).

6. The system according to claim 5, wherein the first gear (44) has more teeth than the second gear (46).

7. The system according to claim 1, wherein the set of planet gears (50) are housed about the circumference of a carrier (48) and the carrier (48) is configured to rotate about the shaft central axis (42).

8. The system according to claim 7, wherein each of the set of planet gears (50) is pinned into the carrier (48) and configured to rotate about the pin.

9. The system according to claim 7, wherein the carrier (48) includes a plurality of teeth configured to engage a clutch pack (56).

10. The system according to claim 9, wherein the clutch pack (56) is configured to transfer torque between the carrier (48) and mechanical ground.

11. The system according to claim 10, wherein the first gear (44), the second gear (46), and the carrier (48) are configured to rotate at a shaft speed of the shaft (30) when the clutch (56) is disengaged.

12. The system according to claim 1, further comprising a plate (58) adjacent to the carrier (48) having spirally formed channels (97) configured to direct lubrication fluid into the middle of the clutch pack (56).

13. The system according to claim 1, wherein the carrier (48) includes scoops (98) configured to direct lubrication fluid into the carrier (48).

14. A torque vectoring system for controlling torque delivered to an axle shaft of a motor vehicle through a differential including a differential carrier, the torque vectoring system comprising:
a shaft (30) configured to receive a torque output from the differential (16) and rotate about a shaft central axis (42);
a first gear (44) in communication with the shaft (30) and configured to rotate in conjunction therewith about the shaft central axis (42);
a second gear (46) in communication with the differential carrier (48) and configured to rotate about the shaft central axis (42), wherein the first gear (44) has a different number of teeth than the second gear (46);
a set of planet gears (50) in communication with the first and second gear (44, 46), wherein at least one planet gear of the set of planet gears (50) engage both the first and second gear (44, 46);
a carrier (48) configured to house the set of planet gears (50) about the circumference of the carrier (48) and the carrier (48) being configured to rotate about the shaft central axis (42);
a coil assembly (66) including a coil (68) to generate an electromagnetic force;
an armature assembly (60) located adjacent the coil assembly (66) such that the electromagnetic force pulls the armature assembly (60) toward the coil assembly (66) when activated, the armature assembly (60) being configured to move axially along the shaft central axis (42);
a clutch pack (56) in communication with the carrier (48); and
a retaining plate (58) attached to the armature assembly (60) and configured to compress the clutch pack (56).

15. The system according to claim 14, wherein the retaining plate (58) is threaded onto an end of the armature assembly (60).

16. The system according to claim 14, wherein threads of the retaining plate (58) are configured such that one revolution of the retaining plate (58) is equal to one millimeter of travel along the shaft central axis (42).

17. The system according to claim 14, wherein the retaining plate (58) is located adjacent to the carrier (48) and includes spirally formed channels (97) configured to direct lubrication fluid into the middle of the clutch pack (56).

18. The system according to claim 17, wherein the carrier (48) includes scoops (98) configured to direct lubrication fluid into the carrier (48).

19. The system according to claim 14, wherein the clutch pack (56) is configured to transfer torque between the carrier (48) and a mechanical ground (62).

20. The system according to claim 14, wherein the first gear (44), the second gear (46), and the carrier (48) are configured to rotate at a shaft speed of the shaft (30) when the clutch (56) is disengaged.

21. The system according to claim 14, wherein the armature assembly comprises:
a tube portion (72) including a threaded segment (79) on a first end and legs (78) extending from the threaded segment (79) with a flange (80) on a second end opposite the first end;
a ring portion (74) having teeth configured to engage the clutch pack (56) and recesses (82) configured to slidably receive the legs (78) of the tubular portion (72).

22. The system according to claim 21, wherein the armature assembly (60) further comprising a plate (76) including recesses (84) along a circumference of an inner opening configured to allow the legs (78) of the tube portion (72) to extend therethrough.

23. The system according to claim 21, wherein an armature (64) of the armature assembly (60) includes tabs (86) and the flanges (80) of the tube portion (72) are configured to engage the tabs (86).
